(19) United States
(12) Patent Application Publication
(10) Pub. No.: US 2010/0079989 A1
(43) Pub. Date: Apr. 1, 2010

(54) Flexible Thin-Type Light-Emitting-Diode Circuit Substrate and a Light-Emitting-Diode Lamp Strip

(76) Inventor: Kuang-Chao YEH, Kuri Shan Shung (TW)

Correspondence Address: Troxell Law Office Pllc, Suite 1404, 5205 Leesburg Pike, Falls Church, VA, 22041, US

(21) Appl. No.: 12/239,759

(22) Filed: Sep. 27, 2008

(51) Int. Cl. F21V 21/00; F21V 7/00

(52) U.S. Cl. 362/235; 362/249.01

(57) ABSTRACT

A flexible thin-type light-emitting-diode circuit substrate includes a bottom copper layer, a top copper layer, and an insulation layer which is interlined between the bottom copper layer and the top copper layer such that the bottom copper layer cannot be electrically connected with the top copper layer. The top copper layer is defined with a wiring zone, and the wiring zone is formed with a circuit pattern for electrically connecting at least one light emitting diode.

### BACKGROUND OF THE INVENTION

a) Field of the Invention

The present invention relates to a light-emitting-diode circuit substrate, and more particularly to a flexible thin-type light-emitting-diode circuit substrate and a light-emitting-diode lamp strip which is formed by applying that circuit substrate.

b) Description of the Prior Art

As being provided with advantages of energy saving, environmental friendliness, high brightness and a long lifetime of usage, a light emitting diode has gradually replaced a conventional light source to be broadly applied in illuminating, an annunciation lamp, a bulletin board of advertisement and a liquid crystal display.

The light emitting diode is a point light source; therefore, in order to increase a range of illumination, for an ordinary illuminating device or electronic device using the light emitting diodes as the light source, a plurality of the light emitting diodes are arranged and configured on a printed circuit board to form a light-emitting-diode lamp set first, and then the light-emitting-diode lamp set is installed in the illuminating device or electronic device. However, the ordinary printed circuit board is not provided with a good heat transfer effect, and therefore is not able to quickly remove heat energy produced by the light emitting diodes when illuminating, thereby affecting a luminous efficacy and a lifetime of usage of the light emitting diodes. Moreover, for an existing light-emitting-diode lamp strip or array which is formed by arranging the plural light emitting diodes on the printed circuit board, a reflector should be assembled additionally that a light condensing effect can be produced to improve brightness of forward illumination, thereby allowing a manufacturing process to be tedious and time consuming.

### SUMMARY OF THE INVENTION

Accordingly, the primary object of the present invention is to provide a flexible thin-type light-emitting-diode circuit substrate which includes a reflector having a highly heat dissipative function and flexibility, as well as being able to be formed integrally.

Another object of the present invention is provide a light-emitting-diode lamp strip which is formed by the light emitting diodes assembled by the flexible thin-type light-emitting-diode circuit substrate.

Accordingly, the flexible thin-type light-emitting-diode circuit substrate of the present invention is provided with a bottom copper layer, a top copper layer, and an insulation layer which is interlined between the bottom copper layer and the top copper layer such that the bottom copper layer cannot be connected electrically with the top copper layer. The top copper layer is defined with a wiring zone which is formed with a circuit pattern allowing at least one light emitting diode to be connected electrically.

The light-emitting-diode lamp strip of the present invention is provided with an aforementioned circuit substrate and a plurality of light emitting diodes provided on the circuit substrate.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a preferred embodiment of a flexible thin-type circuit substrate, in accordance with the present invention.

FIG. 2 shows a cutaway view along a line II-II of FIG. 1.

FIGS. 3 to 7 show schematic views of implementation steps for making a preferred embodiment of the present invention.

FIG. 8 shows a schematic view of a preferred embodiment of a light-emitting-diode lamp strip, in accordance with the present invention.

FIG. 9 shows a cutaway view along a line IX-IX of FIG. 8.

FIGS. 10 to 11 show schematic views for forming a plurality of light-emitting-diode lamp strips, in accordance with the present invention.

FIG. 12 shows a schematic view of a light-emitting-diode lamp strip in a bending process, in accordance with the present invention.

FIG. 13 shows a schematic view of a light-emitting-diode lamp strip used in a direct-view backlight panel, in accordance with the present invention.

FIG. 14 shows a schematic of a light-emitting-diode lamp strip used in a side-view backlight panel, in accordance with the present invention.

### DETAILED DESCRIPTION OF THE PREFERRED EMBODIMENTS

Prior to describing details of the present invention, it is noted that a same number is used to represent similar elements hereinafter.

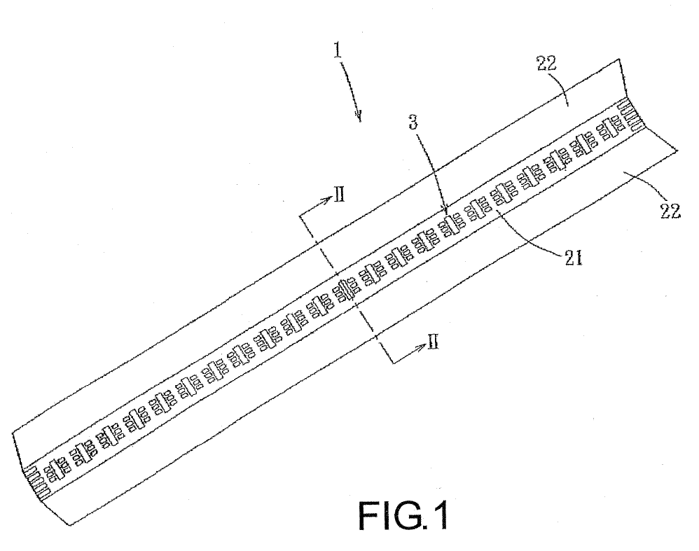

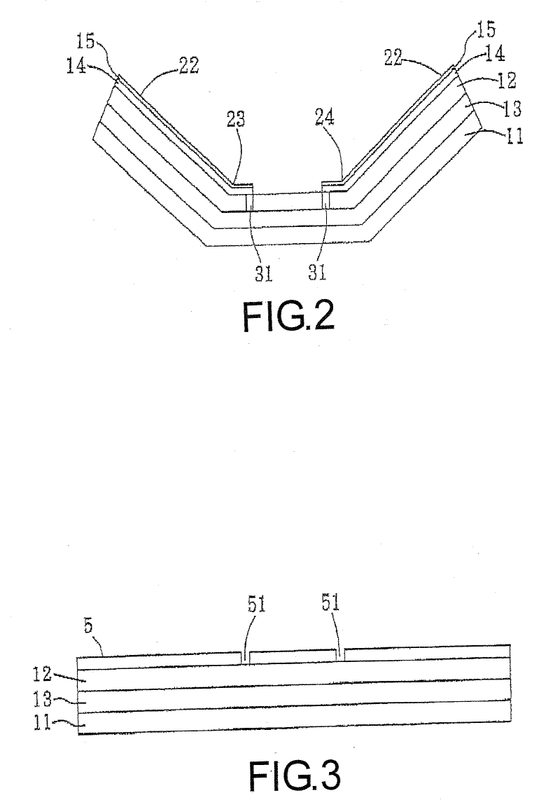

Referring to FIG. 1 and FIG. 2, it shows a preferred embodiment of a flexible thin-type light-emitting-diode circuit substrate, in accordance with the present invention. The preferred embodiment of the present invention is a long-strip circuit substrate 1 comprising a bottom copper layer 11, a top copper layer 12, and an insulation layer 13 which is interlined between the bottom copper layer 11 and the top copper layer 12. The insulation layer 13 can be formed by heat conducting insulation adhesive to glue together the bottom copper layer 11 with the top copper layer 12 and to allow the bottom copper layer 11 not to be electrically connected with the top copper layer 12. The top copper layer 12 is defined with a wiring zone 21 and two reflection zones 22 which are located respectively at two opposite sides of the wiring zone 21 and are adjacent to two long sides of the circuit substrate 1. In the wiring zone 21, a wiring 31 is etched on the top copper layer 12 by etching, so as to form a circuit pattern 3 for installing a plurality of light emitting diodes 4 (as shown in FIG. 8). The top copper layers 12 of the reflection zones 22 are formed respectively with a shining layer 14 and a transparent weld-proof layer 15. The shining layer 14 is used to improve surface smoothness of the top copper layer 12 to increase a probability of reflection when light reaches the reflection zones 22. The transparent weld-proof layer 15 is used to prevent solder from contaminating the reflection zones 22 when assembling the light emitting diodes that an effect of light reflection can be reduced. Each reflection zone 22 is provided respectively with a bending angle 23, 24 corresponding to the wiring zone 21, and each bending angle 23, 24 can be between 90° and 180°. When the light emitting diodes 4 assembled on the circuit substrate 1 illuminate, side light can be reflected using the reflection zones 22 as reflection surfaces, to emit toward a front direction, thereby increasing intensity of forward light. Besides, as a copper foil is a good heat conducting material, heat generated by the light emitting diodes 4 when illuminating can be quickly dissipated by the top copper layer 12, the insulation layer 13 with the heat conduction function, and the bottom copper layer 11, so as to prevent a luminous efficacy of the light emitting diodes 4 from being affected by accumulation of heat energy.

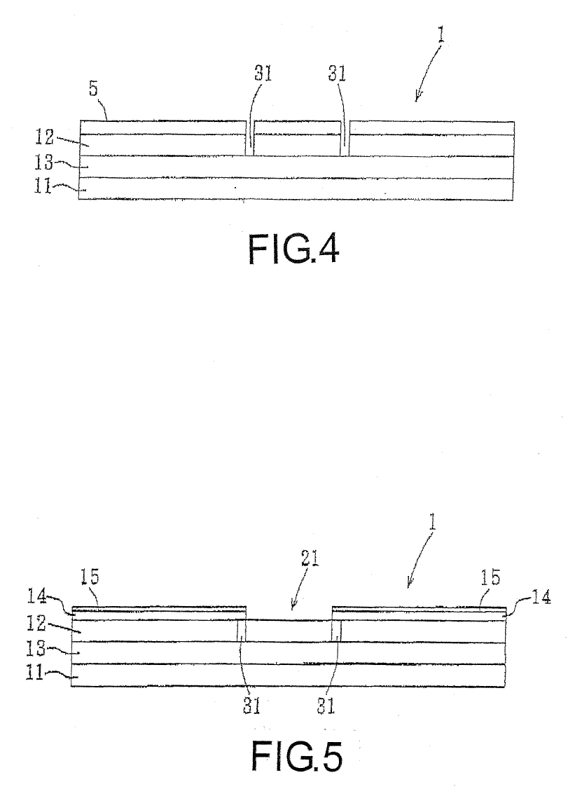

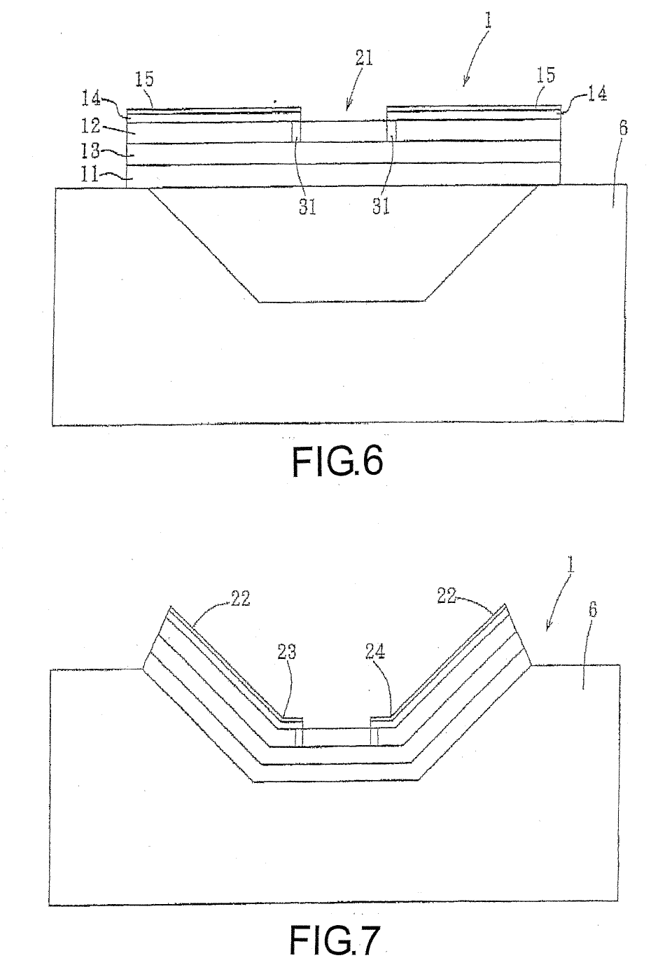

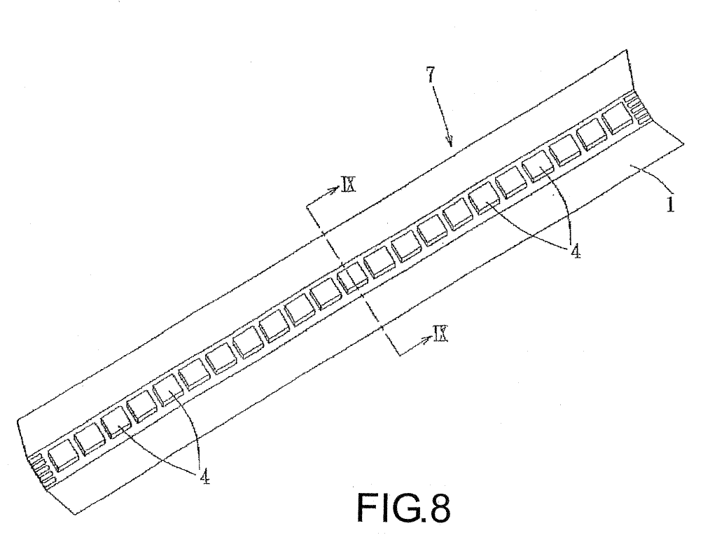

FIGS. 3 to 5 show schematic views of implementation steps for making the circuit substrate 1 of the present invention. As shown in FIG. 3, two copper foils are provided first and surfaces thereof are cleaned, one foil serves as the bottom copper layer 11, and a surface of the bottom copper layer 11 is coated with the heat conducting insulation adhesive. When the adhesive is half solidified, the other copper foil is attached to serve as the top copper layer 12, so as to form the insulation layer 13 after the adhesive has been solidified completely, and to glue together the bottom copper layer 11 with the top copper layer 12. Next, a surface of the top copper layer 12 is printed and coated with etch-resist ink 5 to define a position 51 on the top copper layer 12 where a wiring should be etched. As shown in FIG. 4, by etching, the top copper layer 12 is formed with the wiring 31, so as to form the circuit pattern 3 for installing plural light emitting diodes (as shown in FIG. 1 again). That circuit pattern 3 is defined as the wiring zone 21. As shown in FIG. 5, after etching, the etch-resist ink 5 is removed, and then two sides of the wiring zone 21 are coated with a shining material to form the shining layer 14 which is then coated with transparent weld-proof ink to form the transparent weld-proof layer 15, thereby accomplishing the circuit substrate 1 of the present embodiment. Referring to FIG. 6 and FIG. 7, the circuit substrate 1 can further utilize a mold tool 6 to bend two sides of the wiring zone 21 into the bending angles 23, 24, and to form the defined reflection zones 22.

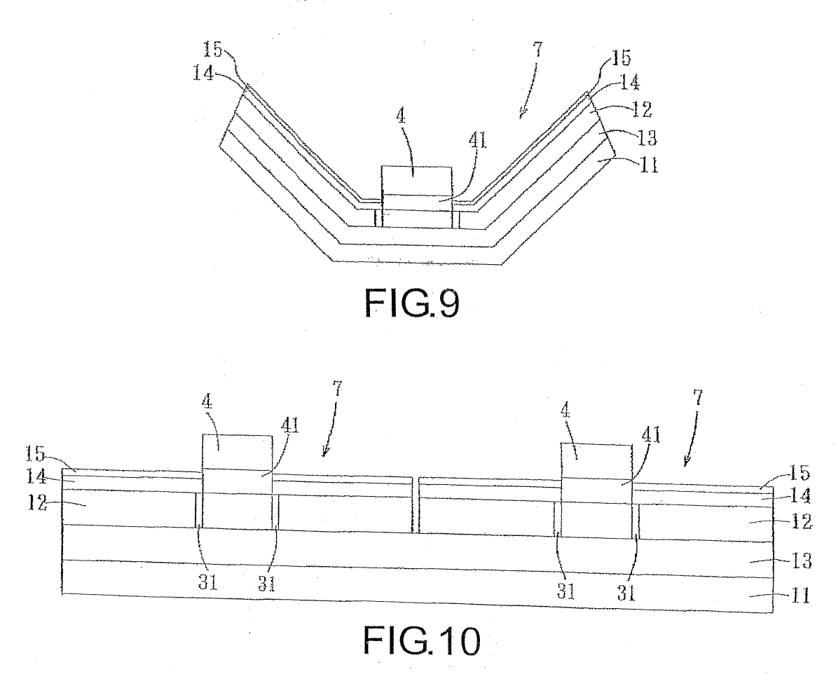

Referring to FIG. 8 and FIG. 9, the light emitting diodes 4 can be glued with the top copper layer 12 by tin 41 to assemble the light emitting diodes 4 on the circuit substrate 1, thereby forming a light-emitting-diode lamp strip 7. In assembling the light emitting diodes 4, the transparent weld-proof layer 15 can prevent surfaces of the light emitting diodes 4 from being attached by the tin 41. The steps for assembling the light emitting diodes 4 can be implemented after or before forming the bending angles 23, 24 to the circuit substrate 1, depending upon a demand of manufacturing process.

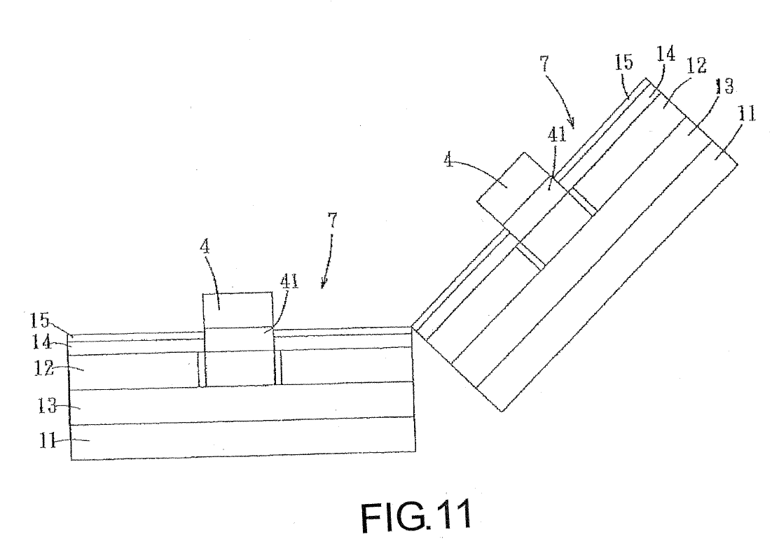

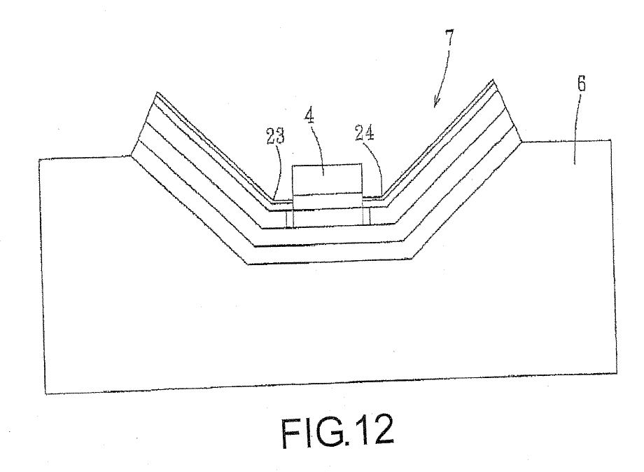

Referring to FIG. 10 and FIG. 11, a preferred method for making the light-emitting-diode lamp strip 7 is to form a basic structure of plural light-emitting-diode lamp strips 7 in one time on a pair of copper foils (can form the bottom copper layer 11 and the top copper layer 12) using the aforementioned implementation steps of printing, coating and etching, and then to separate the connected bottom copper layer 11 and insulation layer 13, thereby forming plural light-emitting-diode lamp strips 7, which is provided with advantages that a manufacturing time can be saved and the production can be accelerated. Referring to FIG. 12, each individual light-emitting-diode lamp strip 7 is emplaced in the mold tool 6 and then the bending angles 23, 24 can be formed. Of course, as shown in the manufacturing process of FIG. 10 and FIG. 11, plural circuit substrates 1 can be formed in one time without providing the tin 41 and the light emitting diodes 4.

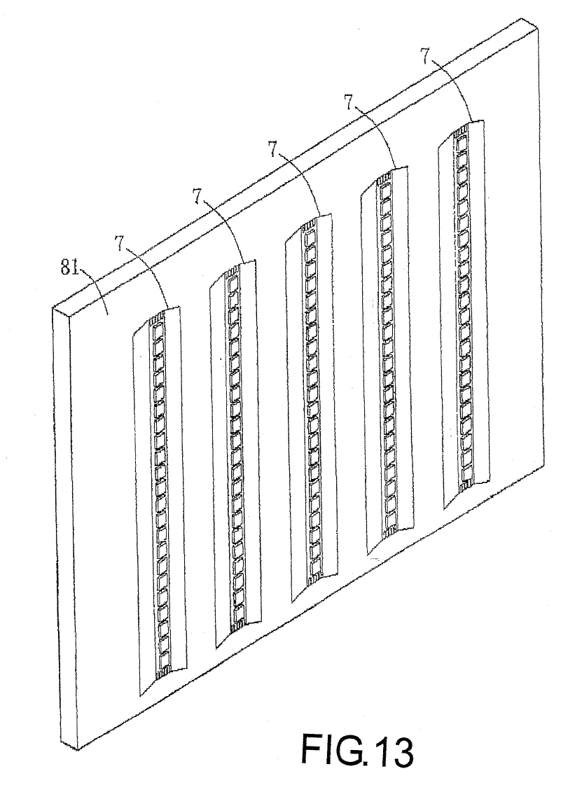

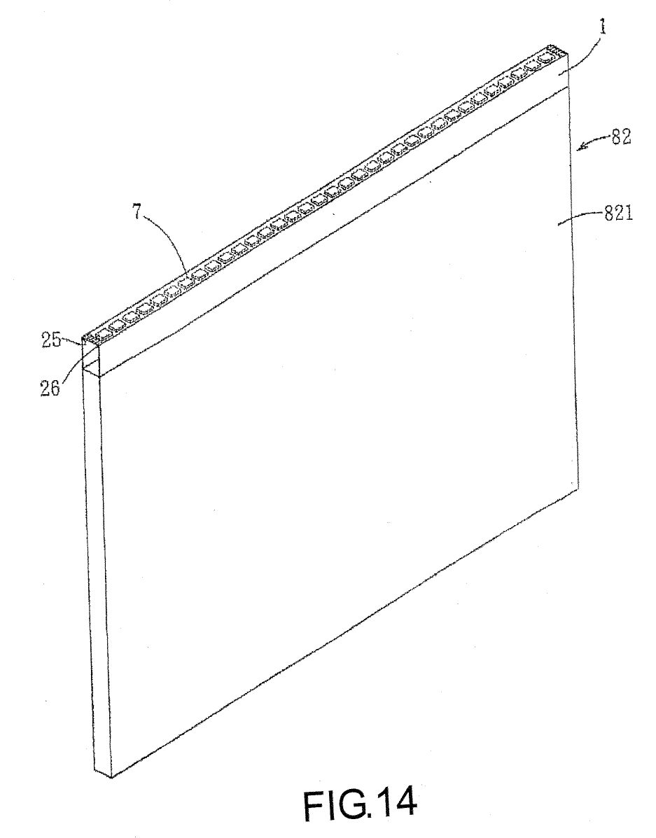

Referring to FIG. 13 and FIG. 14, the light-emitting-diode lamp strip 7 that assembles the light emitting diodes 4 with the circuit substrate 1 of the present invention can be applied to a backlight panel 81, 82 of a liquid crystal display, wherein FIG. 13 shows the direct-view backlight panel 81, on which plural light-emitting-diode lamp strips 7 are arranged to serve as a light source, and FIG. 14 shows the side-view backlight panel 82, with the light-emitting-diode lamps strips 7 being provided at sides of a light guide plate 821 to serve as a light source of the side-view backlight panel 82, and bending angles 25, 26 of the circuit substrate 1 of the light-emitting-diode lamp strips 7 being at 90° that the light-emitting-diode lamp strips 7 can be directly provided at the sides of the light guide plate 821, without further installing a reflection hood, thereby enabling the assembling process to be easier. The present embodiment can be also applied to illuminating lamp sets or bulletin boards of advertisement, which are devices with the light sources.

Accordingly, the flexible thin-type circuit substrate of the present invention is easily bended into the reflection surfaces, and therefore, can increase the brightness of forward illumination of the light emitting diodes 4. In addition, the circuit substrate is highly heat dissipative and can prevent the luminous efficacy of the light emitting diodes 4 from being affected by the accumulation of heat energy. On the other hand, the light-emitting-lamp 7 strip that is formed by assembling plural light emitting diodes is provided with the simple, fast manufacturing process, and allows the illuminating device or the electronic device which uses the lamp strip as the light source to be assembled more easily.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A flexible thin-type light-emitting-diode circuit substrate, comprising a bottom copper layer, a top copper layer, and an insulation layer which is interlined between the bottom copper layer and the top copper layer to allow the bottom copper layer not to be electrically connected with the top copper layer, with the top copper layer being defined with a wiring zone which is formed with a circuit pattern for electrically connecting at least one light emitting diode.

2. The flexible thin-type light-emitting-diode circuit substrate, according to claim 1, wherein the top copper layer is provided with a pair of long sides and is respectively defined with two reflection zones adjacent to the long sides, with the wiring zone being provided between the two reflection zones.

3. The flexible thin-type light-emitting-diode circuit substrate, according to claim 2, wherein the two reflection zones are enclosed by a shining layer.

4. The flexible thin-type light-emitting-diode circuit substrate, according to claim 3, wherein the shining layer is enclosed by a transparent weld-proof layer.

5. The flexible thin-type light-emitting-diode circuit substrate, according to claim 2, wherein each reflection zone is provided respectively with a bending angle corresponding to the wiring zone, with each bending angle being smaller than 180°.

6. The flexible thin-type light-emitting-diode circuit substrate, according to claim 5, wherein each bending angle is larger than or equal to 90°.

7. A light-emitting-diode lamp strip comprising:
a circuit substrate, which is in a long-strip shape and includes a bottom copper layer, a top copper layer, and an insulation layer interlined between the bottom copper layer and the top copper layer such that the bottom copper layer is not electrically connected with the top copper layer, with the top copper layer being defined with a wiring zone that is formed with a circuit pattern; and
a plurality of light emitting diodes which are provided on the wiring zone of the top copper layer and are electrically connected with the circuit pattern.

8. The light-emitting-diode lamp strip according to claim 7, wherein the top copper layer is provided with a pair of long sides and is defined with two reflection zones adjacent to the two long sides respectively, with the wiring zone being provided between the two reflection zones.

9. The light-emitting-diode lamp strip according to claim 7, wherein the two reflection zones are enclosed by a shining layer.

10. The light-emitting-diode lamp strip according to claim 9, wherein the shining layer is enclosed by a transparent weld-proof layer.

11. The light-emitting-diode lamp strip according to claim 8, wherein each reflection zone is provided with a bending angle corresponding to the wiring zone, and each bending angle is smaller than 180°.

12. The light-emitting-diode lamp strip according to claim 11, wherein each bending angle is larger than or equal to 90°.
